(19) United States
(12) Patent Application Publication
(10) Pub. No.: US 2026/0122670 A1
(43) Pub. Date: Apr. 30, 2026

(54) CONTROLLING ACCESS TO A RADIO NETWORK

(71) Applicant: Siemens Aktiengesellschaft, München (DE)

(72) Inventors: Chitiphat Chongaroonngamsaeng, Nonthaburi Province (TH); Ben Mecklenburg, Garching (DE); Michael Bahr, München (DE); Björn Richerzhagen, Ingolstadt (DE)

(21) Appl. No.: 19/159,926

(22) PCT Filed: Mar. 7, 2024
(86) PCT No.: PCT/EP2024/055998

§ 371 Date: Aug. 26, 2025

(30) Foreign Application Priority Data
Mar. 8, 2023 (EP) 23160772.2

(51) Int. Cl. H04W 74/02

(52) U.S. Cl. CPC H04W 74/02

(57) ABSTRACT

A method of controlling access to a radio network includes transmitting, by an access node, a frame for at least one terminal device, wherein the frame causes the terminal device to suspend contention-based access to the radio network by resetting a timer running in the terminal device before its expiration, wherein upon expiration of the timer the terminal device resumes contention-based access to the radio network.

The present patent document is a § 371 nationalization of PCT Application Serial No. PCT/EP2024/055998, filed Mar. 7, 2024, designating the United States, and this patent document also claims the benefit of European Patent Application No. 23160772, filed Mar. 8, 2023, which are incorporated by reference in their entireties.

### TECHNICAL FIELD

The present disclosure relates to the field of wireless communication, in particular in an industrial system. The disclosure further relates to deterministic and/or real-time capable wireless communication.

### BACKGROUND

In recent years, wireless communication has been widely adopted in the field of industrial systems. Compared with traditional wired control and monitoring systems, wireless control and/or monitoring systems as described herein are cost-effective and/or easy to deploy.

In such radio networks, different kinds of data traffic may have diverse real-time requirements. For example, the alarm traffic (e.g., emergency traffic) generated by a safety and/or emergency system may be transmitted with highest priority and/or a hard real-time guarantee.

However, a delay may be present that causes latency when transmitting data. For example, in the CSMA/CA based medium access, all stations in a radio range contend for transmission resources. If a transmission of a station experiences multiple backoff procedures, it may result in a high probability of suffering a long delay when accessing the medium. An overview of delay-sensitive applications, where the timeliness is of vital issue and transmission protocol adaptations to be considered is provided in Y. Cheng, D. Yang, H. Zhou und H. Wang, “Adopting IEEE 802.11 MAC for industrial delay-sensitive wireless control and monitoring applications: A survey,” Computer Networks, p. 27, 2019.

### SUMMARY

It is hence an object to improve the delay of a transmission, in particular, when accessing the medium. It is a further object to provide deterministic access to a radio network, e.g., in order to initiate a scheduled transmission.

The scope of the present disclosure is defined solely by the appended claims and is not affected to any degree by the statements within this summary. The present embodiments may obviate one or more of the drawbacks or limitations in the related art.

### BRIEF DESCRIPTION OF THE DRAWINGS

FIG. 1 illustrates an example of channel access mechanisms according to Wi-Fi 5 (and before).

FIG. 2 illustrates an example of channel access mechanisms according to Wi-Fi 6.

FIG. 3 illustrates an example of channel access mechanisms allowing deterministic channel access.

FIG. 4 shows an illustration of an example of an access point and two stations.

FIG. 5 shows an example of a sequence diagram including the transmission of frames for suspending contention-based access to the radio network.

FIG. 6 shows an exemplary MU-EDCA parameter set.

FIG. 7 shows an example of the transmission of a BSRP frame for suspending contention-based access to the radio network.

FIG. 8 illustrates an example of access delays for different access control types.

FIG. 9 shows an example of different frame types.

FIGS. 10 to 20 show exemplary method acts.

### DETAILED DESCRIPTION

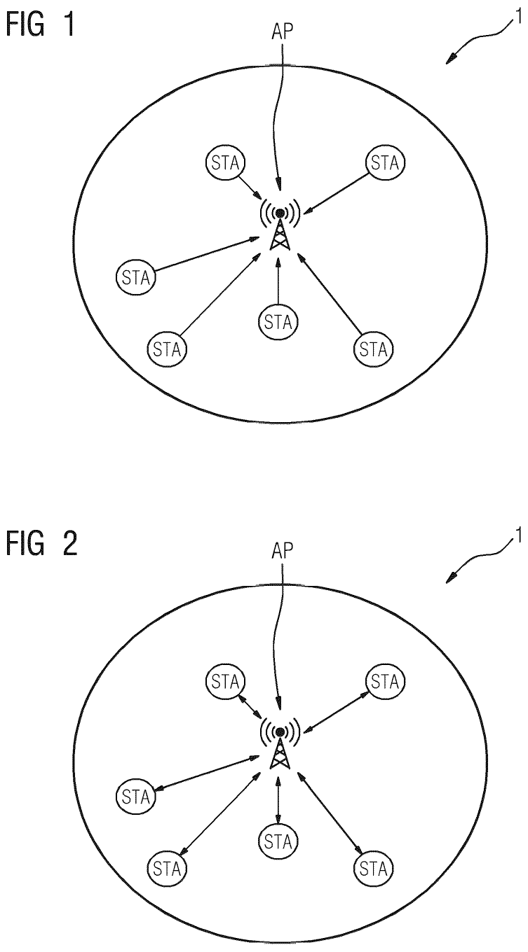

FIGS. 1, 2, and 3 show the conceptual differences between Wi-Fi 5, i.e., IEEE 802.11ac, (and before) and Wi-Fi 6, i.e., 802.11ax, channel access, medium access, or access mechanisms.

In FIG. 1, the distributed approach for Wi-Fi 5 and before is illustrated. Therein, the channel access is based on listen-before-talk (or Carrier Sense Multiple Access/Collision Avoidance (CSMA/CA)). For a transmission, the stations, STAs, (including the AP) may individually try to access the medium. If a station, STA, finds the medium to be idle for a specific amount of time, the STA starts a transmission using the complete sub-channel to which they are assigned. This mechanism is also known as Distributed Coordination Function (DCF). DCF was extended with the Enhanced Distributed Channel Access (EDCA) mechanism that introduced priorities to Wi-Fi in the form of 4 Access Categories (Voice, Video, Background, and Best-Effort). The main goal was to be able to optimize average performance (e.g., latency and jitter) for multi-media traffic.

Wi-Fi 6 brings two major advantages. The first being a new 6 GHz frequency band that may be used by Wi-Fi 6 capable stations and beyond. However, the new 6 GHz frequency band is not available for pre-Wi-Fi 6 stations. This means that for now, only Wi-Fi 6 STAs will be using the 6 GHz band, hence no backwards compatibility issues have to be taken care of in this band. The second major advantage of Wi-Fi 6 compared to legacy Wi-Fi is the use of Orthogonal Frequency Division Multiple Access (OFDMA). With OFDMA, the access point, AP, controls allocation, i.e., allocates, the sub-channel resources, i.e., Resource Units-RUs, more efficiently than for Wi-Fi 5 and earlier Wi-Fi versions. For that, the AP has to contend for the medium (using EDCA, as EDCA is one of the default channel access mechanisms in modern Wi-Fi networks) before centrally performing frequency allocation as shown in FIG. 2. No matter whether a downlink (DL) or uplink (UL) OFDMA transmission may happen, the first thing to happen is the AP winning contention against associated STAs, compared to pre-Wi-Fi 6 where STAs may initiate an UL transmission on their own and block the whole channel, as shown in FIG. 1. Thus, FIG. 2 shows a Wi-Fi or WLAN that includes Wi-Fi 6 and pre-Wi-Fi 6 STAs, e.g., OFDMA transmissions may be initiated by the AP as well as the distributed access may be performed by the STAs.

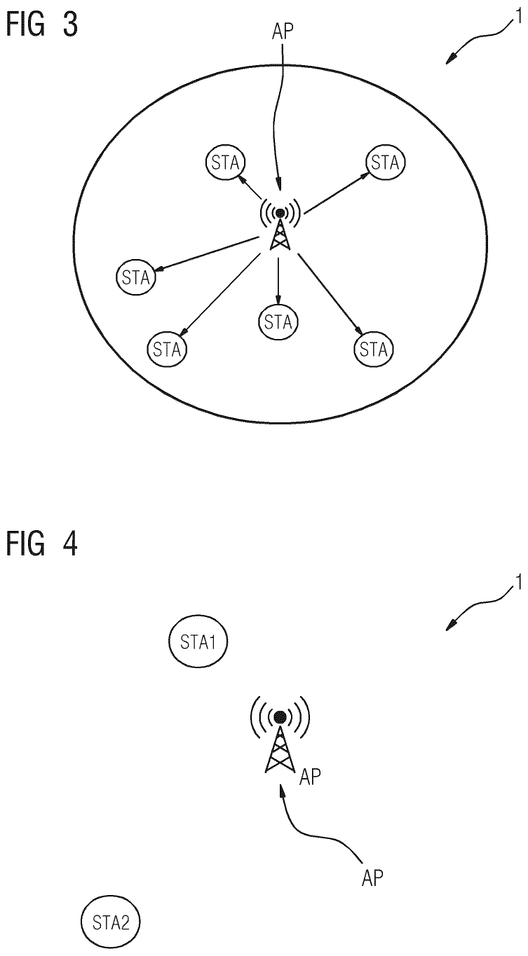

FIG. 3 illustrates an access mechanism allowing deterministic medium access, channel access or access, e.g., to a radio network, in general. Here, the AP is able to centrally perform frequency allocation since the STAs are suspended from accessing the channel/medium. Therefore, the AP may perform deterministic (channel/medium) access in order to initiate a scheduled transmission. The AP may thus access the channel/medium within a predictable, e.g., maximum, time. The one or more stations STA associated with the AP are thus (at least temporarily) not allowed to contend for the medium and/or to perform contention-based access to the radio network, in particular to access the medium or the access channel, for example to perform a transmission to the access node, such as the access point AP.

This results in the AP winning contention and thus being able to initiate a transmission, e.g., OFDMA uplink or downlink transmission. The STAs are thus blocked from channel/medium access, i.e., in the uplink. However, these “blocked” STAs will not starve, as the AP may still allocate resources for UL transmissions, e.g., using OFDMA, of the one or more stations STA and/or thus may even be more efficient than if the one or more stations STA would have done blocking the medium/channel, e.g., using the legacy (MU-)EDCA mechanism. As there are no STAs in the radio network that contend for the channel/medium, the channel/medium access time of an AP (and thus the transmission(s) of the one or more stations, e.g., scheduled by the access point) becomes predictable and/or deterministic.

In certain examples, instead of a station STA, a terminal device such as a user equipment, UE, may be used. Furthermore, instead of an access point an access node, such as a base station, may be used. Still further, instead of a Wi-Fi network 1, a radio network such as mobile radio network, e.g., according to 3GPP Release 18, 17, 16, 15, 14, 13, 12, 11, 10, 9, and/or 8, may be used. In any case, any other access node of a radio network and/or terminal device in the radio network may be used, e.g., that employs contention-based access such as, carrier sense multiple access with collision avoidance, CSMA/CA, and/or carrier sense multiple access with collision detection, CSMA/CD.

FIG. 4 shows an illustration of an access point AP and two stations STA1, STA2.

The one or more stations STA1, STA2 start out as not authenticated and/or associated to the access point, AP. A station STA1, STA2 and the access point AP will exchange a series of management frames, e.g., according to IEEE 802.11ac or 802.11ax, in order to get to an authenticated and associated state, i.e., the station STA1, STA2 being associated to the access point AP.

Three connection states, for example, according to 802.11ac/ax, may be: Not authenticated or associated; Authenticated but not yet associated; or Authenticated and associated.

A station STA1, STA2 may actively or passively scan for a radio network 1 such as a wireless network.

A station STA1, STA2 may send a probe request to discover a radio network 1 within its proximity. Thereupon a probe response may be sent by the AP advertising the SSID (wireless network name), supported data rates, encryption types if required, and/or other 802.11ac/ax capabilities of the AP. The station STA1, STA2 may then send an authentication frame to the AP. The AP receives the authentication frame and/or responds to the station STA1, STA2 with an authentication frame set. At this point, the station STA1, STA2 is authenticated but not yet associated.

If an AP receives any frame other than an authentication or probe request from a station STA1, STA2 that is not authenticated it will respond with a deauthentication frame placing the station STA1, STA2 into an unauthenticated and/or unassociated state.

A station STA1, STA2 may be authenticated to multiple APs, however, it may only be (actively) associated to a single AP (at a time). Multi-connectivity however is considered in IEEE 802.11be/Wi-Fi 7, i.e., a station may then be allowed to actively connect to multiple access points.

The station STA1, STA2 then sends an association request to the AP. The association request may contain an encryption type and/or other compatible 802.11ac/ax capabilities. The AP may then send a success message granting radio network access to the station STA1, STA2.

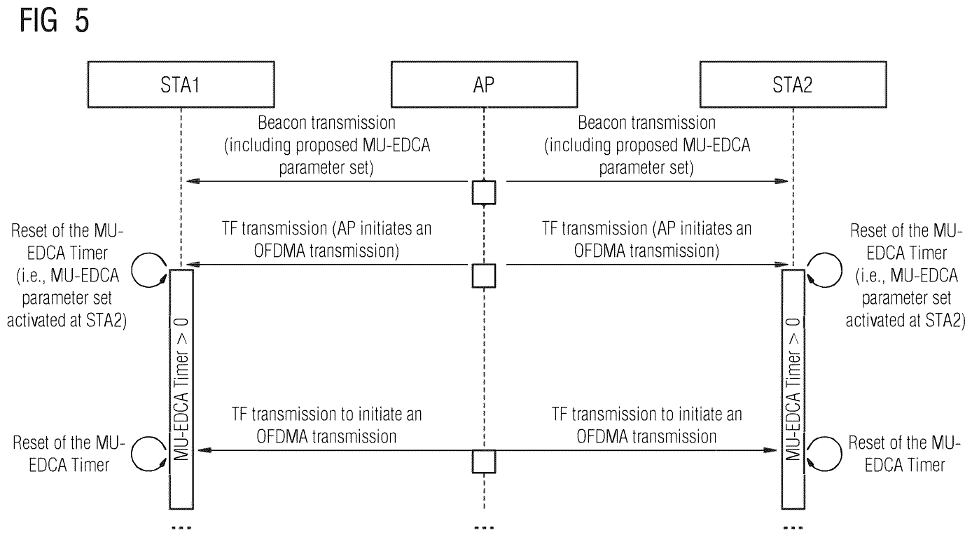

Alternatively, a station STA1, STA2 may passively scan for an access point AP. To that end, the station STA1, STA2 listens on beacon frames that the AP periodically sends in each channel to obtain AP information. Such a beacon frame, e.g., as shown in FIG. 5, may contain information including the SSID and/or supported data rate of the AP.

Hence, the station STA1, STA2 may be associated with the access point AP.

Now, access mechanisms, to the channel/medium and/or the radio network, e.g., in Wi-Fi, may operate based on distributed mechanisms (Distributed Coordination Function (DCF) and/or Enhanced Distributed Channel Access (EDCA)) and/or in a listen-before-talk mode, such as CSMA/CA. EDCA is a mechanism that is optimized for high throughput and average latency, but not for deterministic and/or worst-case transmission delays. In particular, industrial applications require deterministic and/or real-time capable wireless communication, with guaranteed medium/channel access. Industrial applications may be based on polling-based or TDMA-based mechanisms with high implementation complexity, which may not be IEEE 802.11ac/ax compliant, i.e., proprietary solutions. For example, in Wi-Fi 6, using Orthogonal Frequency Division Multiple Access (OFDMA), employs a paradigm shift from distributed channel access to centrally controlled, i.e., scheduled, transmissions. That is, the AP is in control of initiating OFDMA transmissions in UL and DL direction using IEEE 802.11ax compliant so called Trigger Frames. However, as IEEE 802.11 networks are backwards compatible, an 802.11ax network has to support both central and distributed media access mechanisms. To cope with this paradigm shift, the IEEE developed a new multi-user (MU) extension for EDCA in Wi-Fi 6/IEEE 802.11ax called MU-EDCA. MU-EDCA is designed to reduce the average channel/medium access time of an access point when competing against associated IEEE 802.11ax STAs during channel access. MU-EDCA reduces the average channel/medium access time of an AP. However, it is currently not capable of guaranteeing worst-case medium/channel access delays that are required for in industrial solutions.

Originally, EDCA introduced four Access Categories, AC, for prioritizing multi-media traffic, e.g., voice and video, over Best-Effort traffic. Each of the four ACs has a separate set of EDCA parameters called Wireless Multimedia, WMM, parameter set.

MU-EDCA as introduced with IEEE 802.11ax allows the AP to adjust channel/medium access parameters of one or more stations and to use another EDCA parameter set called MU-EDCA parameter set. The MU-EDCA parameter set may be distributed (similar to the WMM parameter set) via one or more Beacon Frames. As described herein, the MU-EDCA parameter set may serve as a first access configuration, and the EDCA (WMM) parameter set may serve as a second access configuration.

The MU-EDCA parameter set is meant to downgrade the medium/channel access probabilities of stations using EDCA, as they may require longer arbitration inter-frame spacings, AIFS, and contention window(s) than the parameters of the EDCA (WMM) parameter set.

The MU-EDCA parameter set is supposed to be activated after a successful UL OFDMA transmission and will last for a duration specified by an MU-EDCA parameter, i.e., the MU-EDCA Timer 4.

Thus, using MU-EDCA, the access point AP may reduce the probability of a station, e.g., that just performed an UL transmission to access the channel, in the near future again. However, the current MU-EDCA mechanism does not guarantee a worst-case channel/medium access time for the access point AP, which is required for deterministic channel/medium access, i.e., wireless communication, but optimizes average channel/medium access performance in favor of the access point AP.

Turning to FIG. 5, a sequence diagram illustrating the transmission of one or more frames for suspending contention-based access (of one or more terminal devices, such as the stations) to the radio network. The terminal devices, here station(s) STA1, STA2, may be associated to an access node, such as the access point AP, e.g., according to the mechanism detailed in connection with FIG. 4.

A beacon frame is one of the management frames in IEEE 802.11ac/ax based radio network, therein referred to as Wi-Fi or WLAN. The beacon frame contains (all the) information about the radio network. Beacon frames may be transmitted periodically, they serve to announce the presence of an access point AP, i.e., a WLAN, and/or for synchronization. Beacon frames may be transmitted by the access point (AP), for example, in an infrastructure basic service set (BSS).

The beacon frame(s) may serve for distributing the MU-EDCA parameter set (similar to the WMM parameter set). The beacon frame(s) may thus contain the MU-EDCA parameter set.

When a station STA1, STA2 receives a beacon frame, it thus receives information about the capabilities and/or configuration of that radio network. The station STA1, STA2 may then be configured according to the MU-EDCA parameter set obtained. Thereby, any preexisting MU-EDCA parameter set may be replaced.

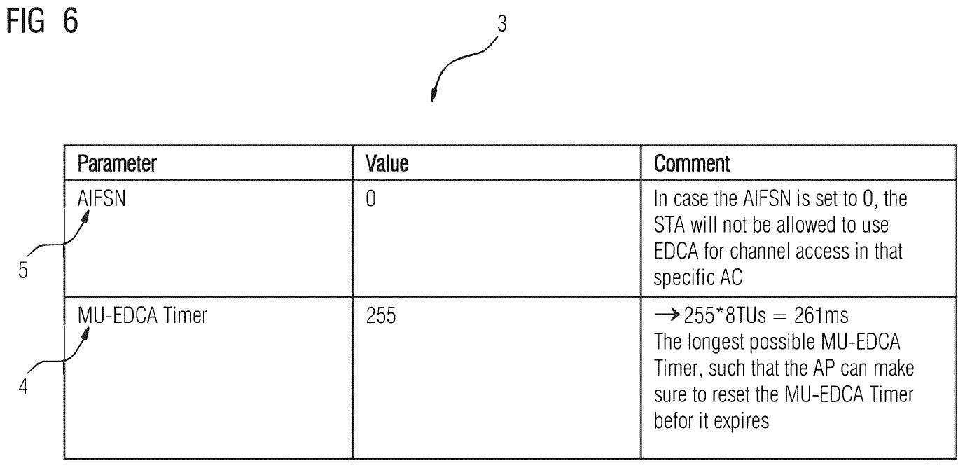

The MU-EDCA parameter set (which may be applied for all 4 EDCA Access Categories (AC)) may include the parameters and/or parameter values as shown in FIG. 6.

The MU-EDCA parameter set may include the parameters AIFSN and MU-EDCA Timer. As shown in FIG. 6, the AIFSN is set to 0, and therefore the station STA1, STA2 will not be allowed to use EDCA, i.e., the EDCA parameter set, for channel/medium access, e.g., in a specific AC. The MU-EDCA Timer is set to a value, e.g., to the longest possible MU-EDCA Timer, such that the access point AP may make sure to reset the MU-EDCA Timer before it expires. The timer reset may be caused by the transmission of frames by the AP—as described herein.

This MU-EDCA parameter set allows for disabling the EDCA-based channel/medium access for the station(s) STA1, STA2 and allows the access point AP to win the contention-based access.

Returning to FIG. 5, for example, after transmission of a beacon frame, the access point AP may transmit a frame that causes stations to suspend contention-based access to the radio network. This frame TF, when received by the station(s) STA1, STA2, will cause the station(s) STA1, STA2 to reset its/their MU-EDCA Timer. Thus, the MU-EDCA Timer of a station STA1, STA2 shall be reset when the AP sends or transmits a frame, e.g., a Trigger Frame, TF, in particular one or more specific kind(s) of Trigger Frames TF, to the one or more stations STA1, STA2, for example instead of and/or in addition to the reset of the MU-EDCA timer at the end of a successful UL OFDMA transmission, for example as defined in IEEE 802.11ax.

As the access point AP controls transmission of these frames, which may also be referred to as suspension frame(s), to the stations STA1, STA2, it may now control when and/or how often the stations STA1, STA2 reset its/their MU-EDCA Timer. The access point AP may thus reset the timer before it expires, such that the station or stations STA1, STA2 will be using the first access configuration, e.g., the parameter set proposed in FIG. 6, and thus not be able to use a second access configuration, e.g., according to EDCA, i.e., the EDCA (WMM) parameter set, for a transmission.

As all associated stations STA1, STA2 (or at least a subset thereof) may receive these frame(s) from the AP, the timer, specifically the MU-EDCA Timer, will be reset for all associated STAs (or at least a subset thereof)—and not only for STAs that participated in an UL OFDMA transmission immediately before.

The proposed mechanism, i.e., modification to the MU-EDCA mechanism, thus does not allow associated stations STA1, STA2 to contend for the channel/medium. This results in the access point AP winning contention and thus being able to initiate/schedule an, e.g., OFDMA, uplink and/or downlink transmission for the, e.g., associated, stations STA1, STA2. Overall, the proposed approach may be considered as a way of blocking one or more stations STA1, STA2 from channel/medium access, e.g., in the uplink. However, these blocked one or more stations STA1, STA2 will be able to perform transmission, as the access point AP is still going to allocate resources for, e.g., UL transmissions of the stations STA1, STA2, e.g., using OFDMA (even more efficiently than if the stations STA1, STA2 would have done blocking the channel/medium using the legacy EDCA mechanism, e.g., in OFDM-based transmissions).

Thus, since now there are no stations STA1, STA2 (or a reduced number of stations) in the radio network that contend for the channel/medium (given that the 6 GHz band and/or the MU-EDCA parameter set, e.g., as shown in FIG. 6, is enabled), the channel/medium access time of an access point AP and/thus also the transmissions of the one or more stations STA1, STA2 becomes predictable/deterministic.

The access AP will thus win contention against its associated stations STA1, STA2, e.g., according to multi-user EDCA, MU-EDCA, introduced with IEEE 802.11ax/Wi-Fi 6.

In a radio network that includes IEEE 802.11ax-compliant stations only (e.g., in the 6 GHz band), MU-EDCA may be used to increase the probability of the access point AP winning medium/channel access against the stations STA1, STA2.

The MU-EDCA parameters may at first not be available to the one or more the stations, i.e., may not be stored, e.g., in a memory of a station. The MU-EDCA parameters may be sent or transmitted by the AP in a beacon and thus stored on and/or activated by the one or more stations, e.g., as soon as a UL OFDMA transmission was successful. However, it may be more flexible to send or transmit MU-EDCA parameters with one or more control frames (e.g., trigger frames TF). This allows to adapt the first access configuration faster, e.g., than with a beacon frame that is only sent every 100 ms by default. A further aspect is the permanent activation of the first access configuration, e.g., the MU-EDCA parameter (set), based on a reset of a timer, e.g., the MU-EDCA timer, such as for the one or more stations STA1, STA2, e.g., associated with an access point AP. The reset may be controlled by the transmission of one or more frames, e.g., trigger frames TF, by the access point, or access node in general. This frame or frame type may also be referred to as suspension frame as it suspends the contention-based access of the terminal device (to the radio network).

Instead, or in addition to the MU-EDCA parameters being included in the beacon frame, the MU-EDCA parameters present in the station may be used and/or activated by a flag in a frame, such as the beacon frame. Thus, a flag, e.g., in the form of one or more bits in the beacon frame, may be transmitted by AP. For instance, a flag in a Capabilities Information Element (IE) of a beacon frame may be used. This flag will indicate to the associated STAs to use and/or active the MU-EDCA parameters or MU-EDCA parameter (set), e.g., according to FIG. 6. In addition, the frame containing such an indication, e.g., in the form of the flag mentioned, may cause the MU-EDCA timer of the station(s) to be reset.

Furthermore, a flag in a frame sent by the AP, for instance, a flag in the Common Info field in a frame, e.g., a BSRP frame, may be used for causing the station(s) to use and/or active the MU-EDCA parameter(s) and/or to reset the MU-EDCA Timer. This flag may indicate to the station(s) that receive the BSRP to the use the (modified) MU-EDCA parameters and/or to reset the MU-EDCA Timer.

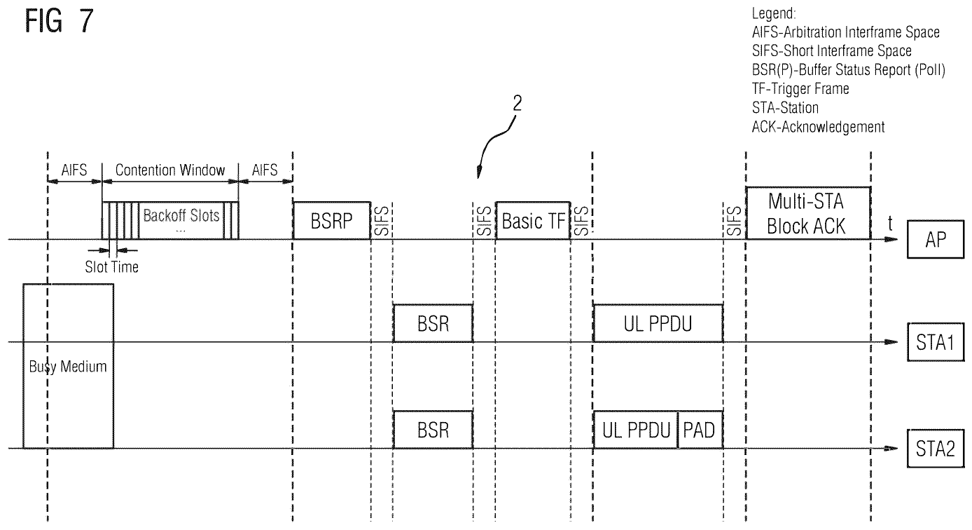

Turning to FIG. 7, an embodiment is shown including the transmission of a first frame, such as a BSRP frame, and/or a second frame, such as a Basic Trigger Frame, for suspending contention-based access to the radio network. Again, as before, two stations STA1, STA2 associated with an access point AP are shown.

It is proposed to reset the MU-EDCA Timer when one or more stations, STAs, receive a frame such as a Buffer Status Report Poll, BSRP, frame from the access point, AP. The BSRP frame is a frame type that is standardized by IEEE 802.11ax. The BSRP frame has been chosen, as it is a vital part of an UL OFDMA transmission. Its purpose is that the AP may query associated STAs using the BSRP frame for traffic they have buffered. STAs answer a BSRP with a Buffer Status Report, BSR, frame that contains information of packets that the station(s) want to send to the AP, such as payload size or QoS requirements of buffered data traffic. Hence, the BSRP may be used in most of the UL OFDMA transmissions.

As shown in FIG. 7, the channel/medium may be busy at first, i.e., one or more stations transmitting and/or receiving traffic, e.g., in the form of one or more (data) frames, according to their channel and/or resource units allocated by the access point. Following upon such a busy medium is a contention window, during which contention-based access and/or corresponding access attempts of the stations STA1, STA2 and/or the access point AP may take place. However, due to the successful UL transmission the MU-EDCA parameter set of the station(s) STA1, STA2 is activated. This MU-EDCA parameter set will last, i.e., be activated, a duration specified by the MU-EDCA Timer. The MU-EDCA parameter set is meant to downgrade the medium/channel access probabilities of STAs using MU-EDCA, as they may require longer AIFS (N) and Contention Window than the parameters of the EDCA (WMM) parameter set, as described herein. Hence, the station(s) STA1, STA2 do not perform a contention-based access in the following contention window in line with their MU-EDCA parameter set values.

Thereupon, the AP gains access to the medium and transmits a BSRP frame, e.g., including new MU-EDCA parameter set, and/or corresponding parameter values, e.g., the ones shown in FIG. 6. The one or more station(s) STA1, STA2 respond (after receiving) the BSRP frame with a BSR frame. As shown, an SIFS may lie between the BSRP frame and the BSR frame. For example, after another SIFS, the access point may transmit a second type of frame, e.g., a control frame, such as a basic trigger frame, denoted as Basic TF in FIG. 7, that causes the station(s) STA1, STA2 to suspend contention-based access, e.g., by resetting the MU-EDCA timer in the MU-EDCA parameter set.

Accordingly, the access point may schedule transmission (opportunities) for the station(s) STA1, STA2. That is to say, the access point AP may allocate transmission resources for a station STA1, STA2 or a plurality of stations, e.g., based on the at least one buffer status report frames received. As shown, the transmission opportunities and the transmission resources relate to UL PPDU transmission. Hence, the station(s) may transmit one or more frames in the uplink, UL, including Physical Protocol Data Unit(s), PPDU, e.g., according to the transmission resources allocated by the access point, e.g., based on the buffer status report from the station(s) STA1, STA2. As shown the access point AP may then acknowledge the reception of the PPDU transmitted by the station(s).

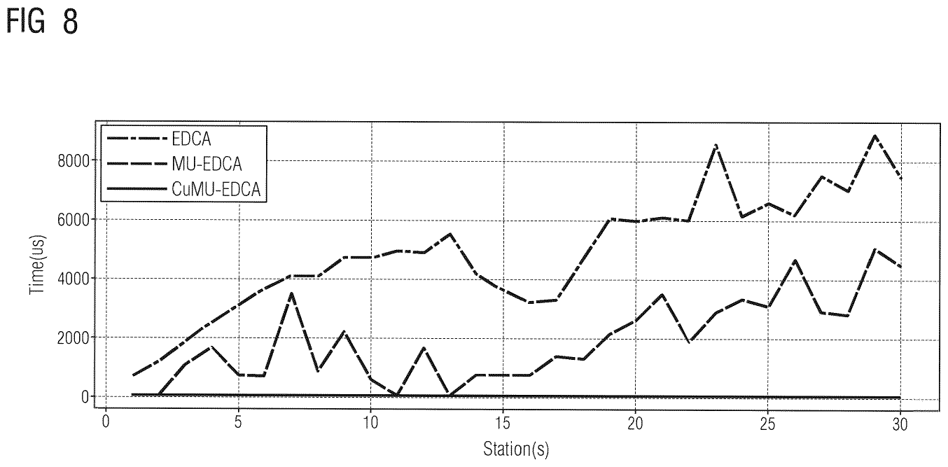

FIG. 8 illustrates access delay for different access control types. The access delay is given as in time units of μs. Therein the worst-case channel access delays for EDCA, MU-EDCA; and the MU-EDCA PARAMETER SET AND MODIFIED MECHANISM, CuMU-EDCA, as proposed herein are illustrated.

As may be seen, the access time or access delay increases with the number of stations when EDCA or standard MU-EDCA is used, whereas the access time or access delay stays constant when the modified mechanism as proposed herein is employed, i.e., when the access point transmits frames that cause the stations to suspend the contention-based channel access.

With changing the configuration of the MU-EDCA parameters in favor of the AP and modifying the MU-EDCA mechanism as proposed herein, a worst-case channel access time for the AP of maximum 55 μs may be achieved. FIG. 8 shows a comparison of the worst-case channel access times of an AP for standard-compliant EDCA (upper curve), MU-EDCA (middle curve) and the modified version of MU-EDCA (called CuMU-EDCA; lower, flat line curve).

An IEEE 802.11ax network with up to 30 STAs has been simulated in order to arrive at the curves shown in FIG. 8. The worst-case channel/medium access delay of an AP may be calculated as follows:

$$Delay = SIFS + ( AIFSN + CW ) * ST$$

where: Delay=channel access delay, SIFS=Short Inter-frame Space, AIFSN=Arbitration Inter-frame Space Number, CW=Contention Window, ST=Slot Time.

For the simulation of a Wi-Fi 6 scenario, this results in maximum of 55 μs as the worst-case channel/medium access time for the AP:

$$Delay = SIFS + ( AIFSN + CW ) * ST = 10 μs + ( 2 + 3 ) * 9 μs = 55 μs$$

An alternative realization is to reset the MU-EDCA Timer when the one or more stations, STAs, receive a Basic Trigger Frame sent by the AP. Basic TFs are mandatory for each UL OFDMA transmission, as they are used to synchronize the starting times of an UL OFDMA data transmission (i.e., one SIFS after the Basic TF, the STAs start sending their UL PPDUs simultaneously on their allocated RUs). However, as Basic TFs are mandatory for every UL OFDMA transmission, the MU-EDCA Timer might be reset more frequently than necessary.

Polling-based mechanisms for (semi-)deterministic channel access in radio networks, such as Wi-Fi, already exist (e.g., Point Coordination Function (PCF) or the Hybrid Coordination Function (HCF) Controlled Channel Access (HCCA) or even proprietary products like iWLAN that used a modified version of PCF called industrial PCF).

With the new OFDMA directions in Wi-Fi 6 and beyond, Wi-Fi develops into a more AP centric communication technology (similar as the adoption of OFDMA in the cellular 5G technology). Hence, the aspects and embodiments proposed herein may be applied to the mobile radio networks, e.g., according to 4G, 5G, or 6G specification.

The proposed new solution modifies an existing medium or channel access mechanism, in particular MU-EDCA, to achieve deterministic channel access (delays), particularly in OFDMA-based Wi-Fi (802.11) networks. The major advantages are a reduced, predictable and/or deterministic medium/channel access (delays) for, e.g., OFDMA-based, transmissions in uplink and/or downlink direction. Another advantage is that is easy to implement the proposed modification to the existing MU-EDCA mechanism in Wi-Fi 6.

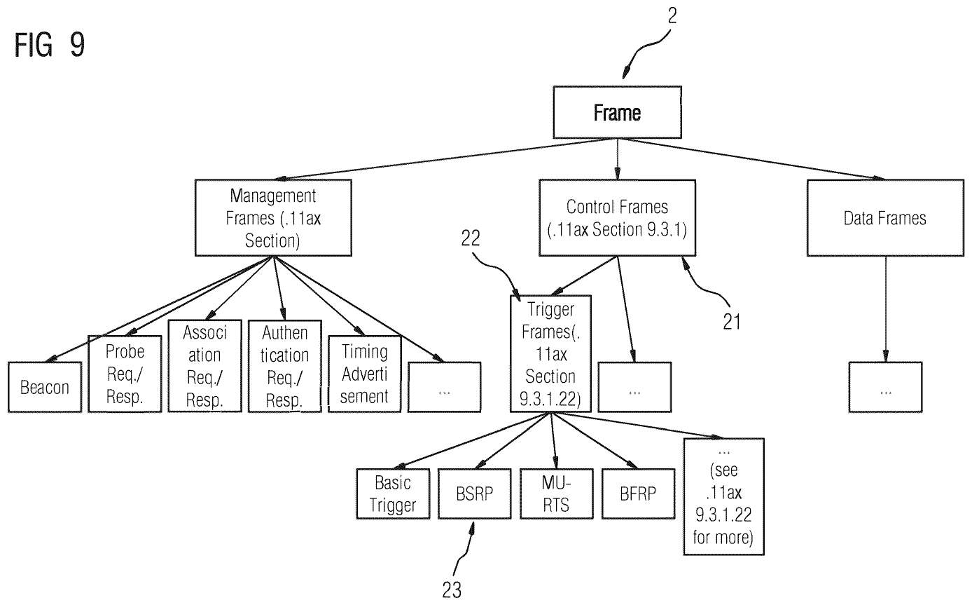

FIG. 9 shows different frame types. Frames of these frame types or frame format may be used to suspend the channel-based access of one or more terminal devices, such as the station(s) discussed herein. As the case may be, one or more frames, e.g., transmitted and/or received by the terminal device(s), may be used to suspend the contention-based access. These frames may therefore be referred to suspension frames.

Three frame types, i.e., management, control, and data frames, according to of 802.11 are shown in FIG. 9. Management frames are used to manage the basic service set, BSS, control frames control access to the medium, and data frames contain payloads, e.g., including information for applications and protocols, such as higher level layers 3-7.

In particular, one or more management frames, i.e., of the management frame type or format, such as Probe Request and/or Probe Response, Association Request and/or Association Response, Authentication Request and/or Authentication Response, Timing Advertisement may be used.

Furthermore, additionally or alternatively, one or more control frames, i.e., of the control frame type or format, such as one or more Trigger Frames may be used. In particular, one or more Basic Trigger frames, one or more Buffer Status Report Poll Trigger frames, one or more MU-RTS Trigger frames, or one or more Beamforming Report Poll Trigger frames may be used. Further frame type or frame formats are provided in section 9.3.1.22 of IEEE Std 802.11ax-2020 and in the amendment IEEE Std 802.11ax-2021.

Finally, additionally or alternatively, one or more data frames may be used in order to may be used to suspend the channel-based access of one or more terminal devices, such as the station(s) discussed herein.

A station, or a terminal device in general, may be operative and/or configured to suspend contention based access upon or after receiving such a suspension frame.

All 802.11ac/ax frames fall under one of the three types: management, control, or data. A frame may include a header, which in turn includes a frame control field that contains the values for type and subtype of the frame. The type field indicates management, control, or data frames. The subtype field indicates the specific type of management, control, or data frame. One type of a management frame is a beacon (frame), that is transmitted by the access point, e.g., in regular intervals. A beacon frame may contain the configuration of the radio network, such as a WLAN, including whether it supports standards such as 802.11k, 802.11r, the required cipher suites and authentication key management (AKM) methods, whether protection mechanisms are required, etc., as described herein.

As such, the management frame, e.g., the beacon frame, may contain a MU-EDCA parameter set, for example, as shown in FIG. 6 and/or may cause the terminal device(s) to suspend the contention-based access to the radio network.

The control frame may be a request-to-send (RTS) and/or clear-to-send (CTS) frame. A control frame may be used control access to the medium and/or for frame acknowledgement. Control frames may only contain a header and trailer, i.e., no body. Thus, a combination of management frame and control frame is possible to suspend contention-based access to the radio network for one or more terminal devices. That is, at first, a management frame is transmitted and subsequently a control frame is transmitted in order to suspend contention-based access, i.e., to cause the terminal device to suspend contention-based access to the radio network. In any case, a combination of control frames may also be used to, at first, inform the terminal device with a first access configuration and/or activate the first access configuration and/or to suspend the contention-based access of the terminal device, e.g., by resetting a timer of the terminal device.

Finally, data frames may be used to transfer information or trigger an event. As such also data frame(s) may be used to suspend contention-based access, i.e., to cause the terminal device to suspend contention-based access to the radio network, e.g., by resetting the timer of the terminal device. Not all data frames contain a payload, some are “null data frames” and only contain a header and trailer. For example, one or more broadcast or multicast frames may be transmitted by the access point to suspend contention-based access, i.e., to cause the terminal device to suspend contention-based access to the radio network, i.e., accessing the medium/channel.

For exemplary purposes, a system with an access point and stations according to IEEE 802.11ax are described, but the teachings disclosure herein are applicable to other radio or wireless systems, in particular those employing contention-based access.

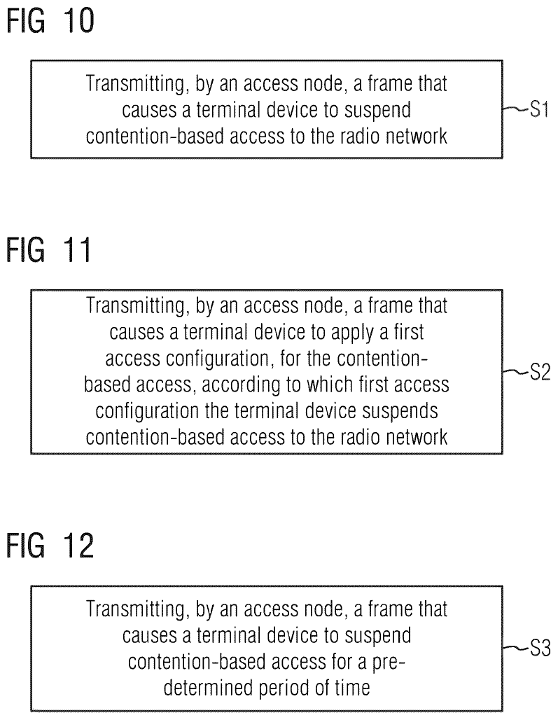

Turning to FIG. 10, an exemplary method act S1 is shown. In act S1, an access node may transmit a frame that causes a terminal device to suspend contention-based access to the radio network. As already mentioned, such a frame may be referred to as a suspension frame. In particular, the terminal device may suspend contention-based access to an access node, e.g., an access point, of the radio network. Hitherto, the terminal device may be associated with the access node or access point, e.g., as described herein. The frame may be any one of the frames as described herein in particular with respect to FIG. 9. The access node may transmit the frame for a terminal device to be received either by way of a beacon or a broadcast or multicast. In any case, the frame may be destined for one or more or all terminal devices (associated with the access node). As such the frame may include a destination address that corresponds to the address of the one or more terminals for which the frame is destined. The transmission allows the access node to control access to a radio network.

Hence, a method of controlling access to a radio network 1 is proposed. The method including transmitting, by an access node AP, a frame 2 for at least one terminal device STA, STA1, STA2, wherein the frame 2 causes the terminal device STA, STA1, STA2 to suspend contention-based access to the radio network 1.

In certain examples, the frame 2 causes the terminal device STA, STA1, STA2 to apply a first access configuration 3, for the contention-based access, according to which first access configuration 3 the terminal device STA, STA1, STA2 suspends contention-based access to the radio network 1.

In certain examples, the frame 2 causes the terminal device STA, STA1, STA2 to suspend contention-based access for a predetermined period of time.

In certain examples, the frame 2 causes a timer of the terminal device STA, STA1, STA2 to be reset, wherein based upon expiration of the timer 4 the termina device STA, STA1, STA2 resumes contention-based access to the radio network 1.

In certain examples, upon expiration of the timer 4, the terminal device STA, STA1, STA2 resumes contention-based access according to a second access configuration.

In certain examples, the frame 2 includes one or more parameters 4, 5 for configuring the first access configuration 3, in particular for configuring an AIFSN and/or an MU-EDCA timer.

In certain examples, the timer 4 of the terminal device STA, STA1, STA2 is initiated and/or reset after a successful contention-based access of the terminal device STA, STA1, STA2.

In certain examples, the frame 2 causes each one of a predetermined number of terminal devices STA, STA1, STA2, e.g., the majority of terminal devices or all terminal devices, STA, STA1, STA2 associated with the access node AP to suspend contention-based access to the radio network 1.

The method may include repeatedly, e.g., periodically, transmitting the frame 2 to the at least one terminal device STA, STA1, STA2 in order to suspend contention-based access to the radio network 1 of the at least one terminal device STA, STA1, STA2.

The method may include using at least one control frame type 21, e.g., a trigger frame 22 or a buffer status report poll 23, as a frame 2 that causes the at least one terminal device STA, STA1, STA2 to suspend contention-based access to the radio network 1.

The method may include using different types of control frames 21 as frames that cause the terminal device to suspend contention-based access to the radio network, wherein a first type of control frame 22 includes one or more parameters for configuring the first access configuration 3, and a second type of control frame 22 is devoid of the one or more parameters for configuring the first access configuration 3.

The method may include attempting, by the access node AP, a contention-based access after transmitting the frame 2.

The method may include receiving, by the access node AP, a buffer status report from the at least one terminal device STA, STA1, STA2, e.g., including an acknowledgement.

The method may include allocating, by the access node AP, transmission resources to the at least one terminal device STA, STA1, STA2 for a transmission from the terminal device STA, STA1, STA2 to the access node AP, e.g., based on the at least one buffer status report received.

Furthermore, an access node AP of a radio network 1 is proposed, e.g., including a processor and a memory configured to perform the method acts as described.

Furthermore, a method of controlling access to a radio network 1, is proposed, wherein the method includes receiving, by a terminal device STA, STA1, STA2, a frame 2 from an access node AP of the radio network 1, wherein the frame 2 causes the terminal device STA, STA1, STA2 to suspend contention-based access to the radio network 1.

Still further, a terminal device STA, STA1, STA2 of a radio network 1 is proposed, e.g., including a processor and a memory configured to perform the method acts of the preceding method.

Turning to FIG. 11, an exemplary method act S2 is shown. In act S2, the access node may transmit a frame that causes the terminal device to apply a first access configuration, for the contention-based access, according to which first access configuration the terminal device suspends contention-based access to the radio network. The first access configuration may include one or more parameters according to which the contention-based access is performed. For example, the first access configuration may correspond to an MU-EDCA parameter set as described herein.

Turning to FIG. 12, an exemplary method act S3 is shown. In act S3, the access node may transmit a frame that causes the terminal device to suspend contention-based access for a pre-determined period of time.

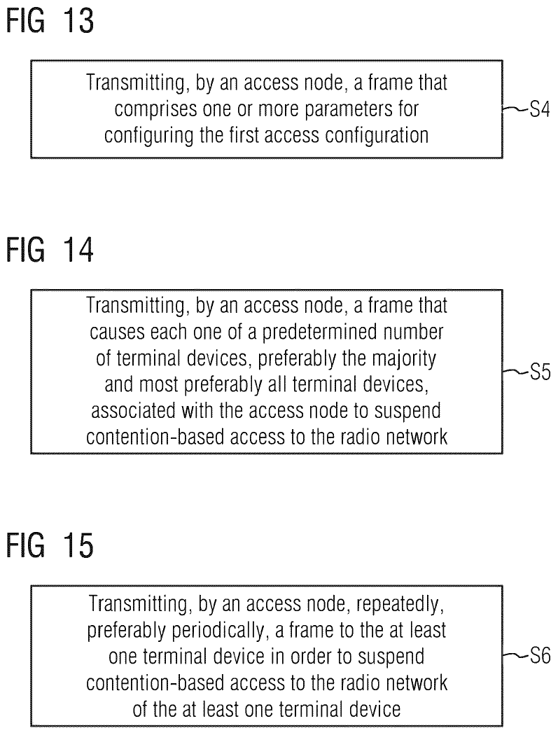

Turning to FIG. 13, an exemplary method act S4 is shown. In act S4, the access node may transmit a frame that causes a timer of the terminal device to be reset, wherein based upon expiration of the timer the terminal device resumes contention-based access to the radio network. The timer may run in the terminal device.

Upon expiration of the timer the terminal device may resume contention-based access according to a second access configuration. The second access configuration (for the contention based access) may also be stored in the terminal device. The second access configuration may correspond to the EDCA parameter set, also known as and referred to as the WMM parameter set.

Turning to FIG. 13, an exemplary method act S4 is shown. In act S4, the access node may transmit a frame that includes one or more parameters for configuring the first access configuration, such as the MU-EDCA parameter set. The parameters included in the frame may be or may serve for configuring the first access configuration, e.g., a parameter such as an AIFSN and/or an MU-EDCA timer.

As described herein, the timer of the terminal device is initiated and/or (re-)set after a successful contention-based access of the terminal device. During the runtime of the timer the terminal device(s) thus relies upon the first access configuration for performing contention-based access. In particular, the first access configuration may prohibit contention-based access to the radio network, in particular during the runtime of the timer. Alternatively, the first access configuration may include setting with an extended backoff period that deteriorate a probability of contention-based access, e.g., by a high AISFN setting. The second access configuration is employed by the terminal device(s) when the timer expires or runs out. The second access configuration may allow a contention-based access to the radio network. As described herein, the timer is (re-)initiated or (re-)set after a successful contention-based access and/or transmission of the terminal device. Thereby, the first access configuration is used by the terminal device for accessing the radio network, reducing the chances of an immediate medium access by the terminal device.

Turning to FIG. 14, an exemplary method act S5 is shown. In act S5, the access node may transmit a frame that causes each one of a predetermined number of terminal devices, e.g., the majority of terminal devices or all terminal devices, associated with the access node to suspend contention-based access to the radio network. As the case may be, the one or more terminal devices for which the timer is to be reset may be determined by the access node or another network function. Subsequently, the access node may transmit the frame to be received by the terminal devices, e.g., as a management frame and/or a control frame. Hence by resetting the timer of at least some of the terminal devices, i.e., by suspending the contention-based access of those terminal devices, associated with the access point, the probability of the access point winning the contention-based access is increased.

Turning to FIG. 15, an exemplary method act S6 is shown. In act S6, the access node may repeatedly, e.g., periodically, transmit a frame to the at least one terminal device in order to suspend contention-based access to the radio network of the at least one terminal device. The repetition may be periodic as in the case of beacon frames that are transmitted according to a beacon period or interval, e.g., every 102.4 ms.

It may be the same frame that is transmitted by the access node that includes the properties described in connection with any one of the FIG. 10-15 and/or that causes the terminal device to perform the acts described herein. In any case, it may nonetheless be separate frames with the properties described in connection with FIGS. 10-15 that are transmitted by the access node.

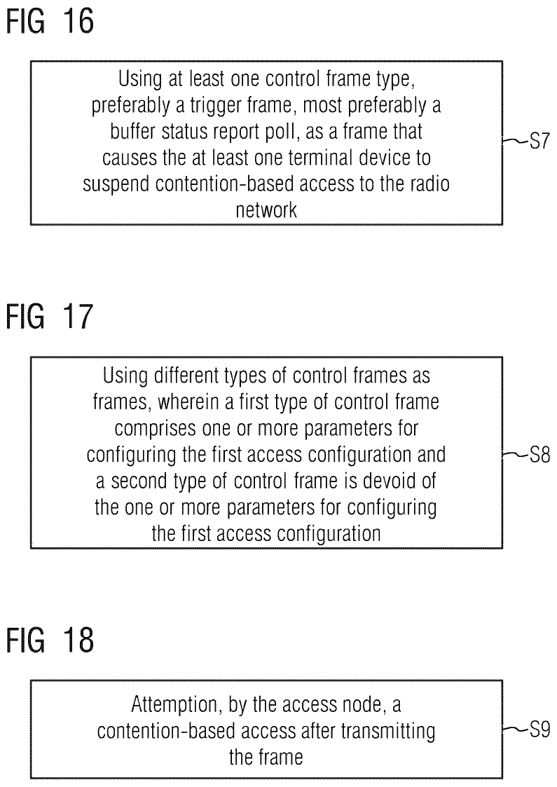

Turning to FIG. 16, an exemplary method act S7 is shown. In act S7, at least one control frame type, e.g., a trigger frame or a buffer status report poll, is used as a frame that causes the at least one terminal device to suspend contention-based access to the radio network, e.g., as described herein.

Turning to FIG. 17, an exemplary method act S8 is shown. In act S8, different types of control frames may be used as the frames, wherein a first type of control frame includes one or more parameters for configuring the first access configuration, e.g., the MU-EDCA parameter set, and a second type of control frame is devoid of, i.e., does not include, the one or more parameters for configuring the first access configuration. As mentioned earlier, and even more general, the first frame may be a management frame such as a beacon frame and the second frame may be a control frame such as a trigger frame such as a Basic Trigger Frame.

Turning to FIG. 18, an exemplary method act S9 is shown. In act S9, the access node may attempt a contention-based access after transmitting the frame. That is the access node is guaranteed to succeed in accessing the medium or at least the chances are improved dependent on the specific embodiment chosen as described herein.

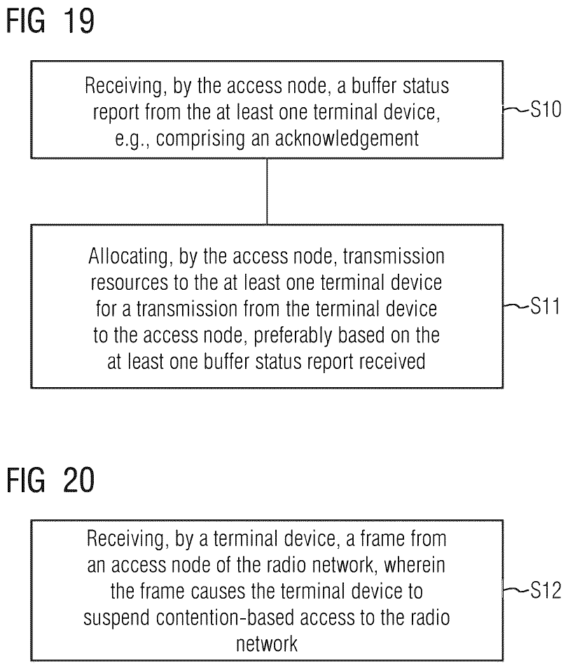

Turning to FIG. 19, exemplary method acts S10 and S11 are shown. In act S10, the access node may receive a buffer status report from the at least one terminal device, e.g., including an acknowledgement. This may be for example the case if a BSRP frame is used to suspend contention-based access of the terminal device and/or to reset the timer (in the first access configuration) of the terminal device and/or to transmit the first access configuration to the terminal device.

Subsequently, in act S11, the access node may allocate transmission resources to the at least one terminal device for a transmission from the terminal device to the access node, e.g., based on the at least one buffer status report received.

Turning to FIG. 20, an exemplary method act S12 is shown. In act S12, a terminal device may receive a frame from an access node of the radio network, wherein the frame causes the terminal device to suspend contention-based access to the radio network. The frame may be a frame including any one of the properties as described herein in particular in connection with FIGS. 10-19. The acts described in connection with FIGS. 10-20 may be combined in order to obtain a sequence of successive acts.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method of controlling access to a radio network, the method comprising:
transmitting, by an access node of the radio network, a frame for to at least one terminal device,
wherein the frame causes the at least one terminal device to suspend contention-based access of the at least one terminal device to the radio network by resetting a timer running in the at least one terminal device before an expiration of the timer, and
wherein the at least one terminal device resumes contention-based access to the radio network upon expiration of the timer.

2. The method of claim 1, wherein the frame is transmitted after a successful uplink transmission of the at least one terminal device.

3. The method of claim 1, wherein the timer of the at least one terminal device is initiated after a successful uplink transmission of the at least one terminal device.

4. The method of claim 1, wherein the contention-based access of the at least one terminal device is suspended during a runtime of the timer.

5. The method, of claim 1, wherein the at least one terminal device comprises a plurality of terminal devices,
wherein the plurality of terminal devices associated with the access node receives one or more frames from the access node, and
wherein the timer of a respective terminal device of the plurality of terminal devices is reset.

6. The method of claim 1, wherein the frame is a broadcast or multicast frame.

7. The method of claim 1, wherein the frame causes the at least one terminal device to apply a first access configuration, for the contention-based access, according to which the at least one terminal device suspends the contention-based access to the radio network.

8. The method of claim 1, wherein the frame causes the at least one terminal device to suspend the contention-based access for a predetermined period of time.

9. The method of claim 1, wherein the at least one terminal device resumes the contention-based access according to a second access configuration upon the expiration of the timer.

10. The method of claim 1, wherein the frame comprises one or more parameters for configuring first access configuration comprising configuring an Arbitration Inter-frame Space Number and/or Multi-User Enhanced Distributed Channel Access timer.

11. The method of claim 1, wherein the timer of the at least one terminal device is initiated and/or reset after a successful contention-based access of the terminal device.

12. The method of claim 1, wherein the at least one terminal device comprises a plurality of terminal devices, and
wherein the frame causes each one of a predetermined number of the plurality of terminal devices, a majority of the plurality of terminal devices, or all terminal devices of the plurality of terminal devices associated with the access node to suspend the contention-based access to the radio network.

13. The method of claim 1, further comprising:
repeatedly transmitting the frame to the at least one terminal device in order to suspend the contention-based access to the radio network of the at least one terminal device.

14. The method of claim 1, wherein at least one of a control frame type, a trigger frame, or a buffer status report poll is used as the frame that causes the at least one terminal device to suspend the contention-based access to the radio network.

15. The method of claim 1, wherein the frame comprises different types of control frames that are used for causing the at least one terminal device to suspend the contention-based access to the radio network,
wherein a first type of control frame of the different types of control frames comprises one or more parameters for configuring a first access configuration, and
wherein a second type of control frame of the different types of control frames is devoid of the one or more parameters for configuring the first access configuration.

16. The method of claim 1 further comprising:
attempting, by the access node, the contention-based access after the transmitting the frame.

17. The method of claim 1, further comprising:
receiving, by the access node, a buffer status report from the at least one terminal device,
wherein the buffer status report comprises an acknowledgement.

18. The method of claim 17, further comprising:
allocating, by the access node, transmission resources to the at least one terminal device for a transmission from the at least one terminal device to the access node based on the at least one buffer status report received.

19. An access node of a radio network, the access node comprising:
a processor and a memory configured to:
transmit a frame to at least one terminal device of the radio network, wherein the frame is configured to suspend contention-based access of the at least one terminal device to the radio network by resetting a timer running in the at least one terminal device before an expiration of the timer,
wherein the contention-based access of the at least one terminal device to the radio network is configured to resume upon expiration of the timer.

20.-21. (canceled)
